(19) United States
(12) Patent Application Publication
(10) Pub. No.: US 2014/0052668 A1
(43) Pub. Date: Feb. 20, 2014

(54) System and Method for Crowdfunded Investment Clearance and Compliance

(71) Applicants: Jon Cameron, Dallas, TX (US); Bo Sartain, Dallas, TX (US)

(72) Inventors: Jon Cameron, Dallas, TX (US); Bo Sartain, Dallas, TX (US)

(21) Appl. No.: 13/970,401

(22) Filed: Aug. 19, 2013

Related U.S. Application Data
(60) Provisional application No. 61/684,229, filed on Aug. 17, 2012.

(51) Int. Cl. G06Q 40/06

(52) U.S. Cl. CPC G06Q 40/06
USPC 705/36 R

(57) ABSTRACT

Using an intermediary system, a method of providing entrepreneurs with crowdfunding capital that maintains appropriate monitoring controls, expedites document handling, and efficiently transfers funs between participating parties.

### PRIORITY

This application claims priority to U.S. Provisional Patent Application No. 61/684,229, entitled System for Crowdfund Investing, filed on Aug. 17, 2012, which is incorporated herein by reference.

### BACKGROUND OF THE INVENTION

The invention relates to the system and method of providing crowdfund investment through an intermediary funding portal or online platform for crowdfunded investing, and a Clearinghouse to ensure compliance with statutes and regulations.

The present invention addresses systems and methods for implementing the Jumpstart Our Business Startups Act (“JOBS”), and the rules and regulations promulgated with respect thereto.

The United States Congress enacted Title III of the Jumpstart Our Business Startups Act (“JOBS Act”) in order to permit, and facilitate, investment in startup companies by investors who do not qualify as accredited investors (which includes both income and net worth requirements) required under prior law. Other parts of the Jobs Act ease the on-ramp for public offerings by emerging growth companies. However, both the Act itself and rules and regulations to be promulgated by the U.S. Securities and Exchange Commission (the “SEC”) place certain limitations on investment by such investors, including limits on the amount that any investor may invest during a specific time period, the amount of money that can be raised by any issuer using the exemption and the time during which offers to invest may be revoked.

Additionally, the Act makes the issuer of an investment (i.e., the startup business itself) liable when the investment of one of its investors violates the Act, e.g., by exceeding the annual maximum investment for Title III of the JOBS Act. Accordingly, a centralized means of tracking investments is needed, to ensure that investors and issuers do not become liable based on a non-compliant investment. A centralized means would crosscheck a proposed investment against other investments made by the same investor, in other issuers, and determine, before the investment is made, whether the investor is eligible to make the investment. Furthermore, a system for preparing, standardizing, and storing the investment documents, and filing legally required documents with the SEC would also be preferable.

### SUMMARY OF THE INVENTION

An invention, which meets the needs stated above, is a system and method that allows entrepreneurs access to investor capital while assuring compliance with the rules and regulations established by the SEC under the JOBS Act.

The accompanying drawings, which are incorporated in and constitute a part of this specification, illustrate embodiments of the present invention and together with the description, serve to explain the principles of this invention

### BRIEF DESCRIPTION OF THE DRAWINGS

FIG. 1A. is a flow chart depicting an intermediary-centric preparation of crowdfunding securities documents for initial filing using only the issuer, a background investigator and auditor.

FIG. 1B. is a flow chart showing an intermediary-centric preparation of crowdfunding securities documents for initial filing using the issuer, an background investigator, a document preparer, and auditor.

FIG. 1C. is a flow chart showing an intermediary-centric preparation of crowdfunding securities documents for initial filing using a full team of issuer, background investigator, document preparer, auditor, and document generator.

FIG. 2. Is a flow chart showing the use of a clearinghouse to check inter-intermediary funding commitments to assure they do not exceed a single investor's legal investment limit.

FIG. 3A. is a timeline illustrating the flow of capital contributions when funding continues after the threshold period.

FIG. 3B. is a timeline illustrating the flow of capital contributions when funding stops at the threshold period.

FIG. 4A. is a flow chart depicting the document flow from the point when the investor first queries the intermediary's issuer listings.

FIG. 4B. is a timeline outlining the flow of documents from the SEC document preparation until the threshold is achieved.

FIG. 4C is a timeline illustrating the flow of documents starting from the preparation of the SEC package and ending when the maximum target, or deadline, is achieved.

FIG. 4D is a flow chart depicting the flow of investment documents and data to trigger the document generation.

FIG. 5 is a flow chart illustrating an exemplary crowdfunding system.

FIG. 6 is a is a diagram displaying a general purpose computer on which the system and method of the present disclosure may be implemented according to an aspect of present disclosure.

### DETAILED DESCRIPTION OF THE DRAWINGS

Referring to the drawings, in which like numerals represent like elements:

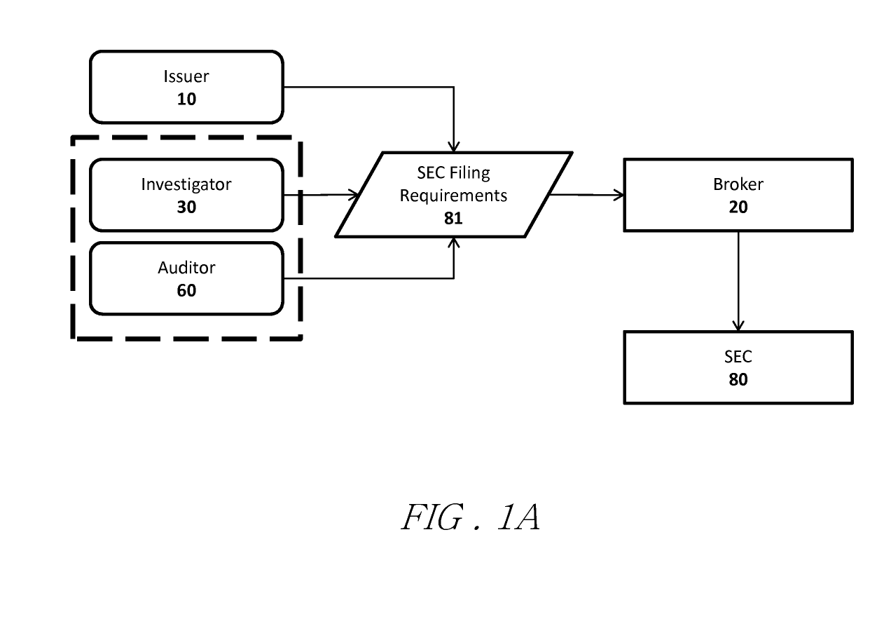

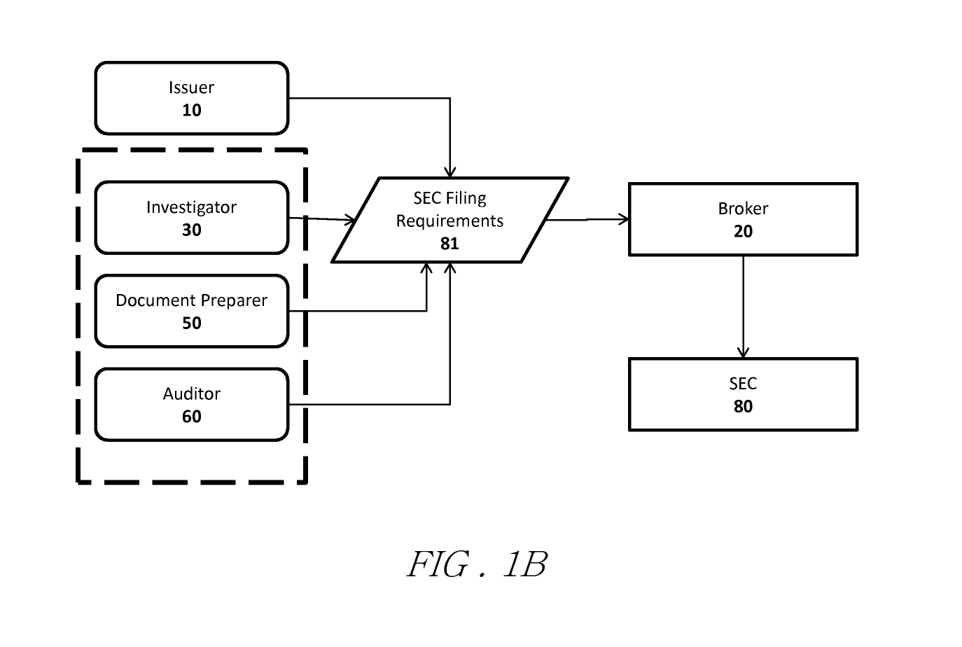

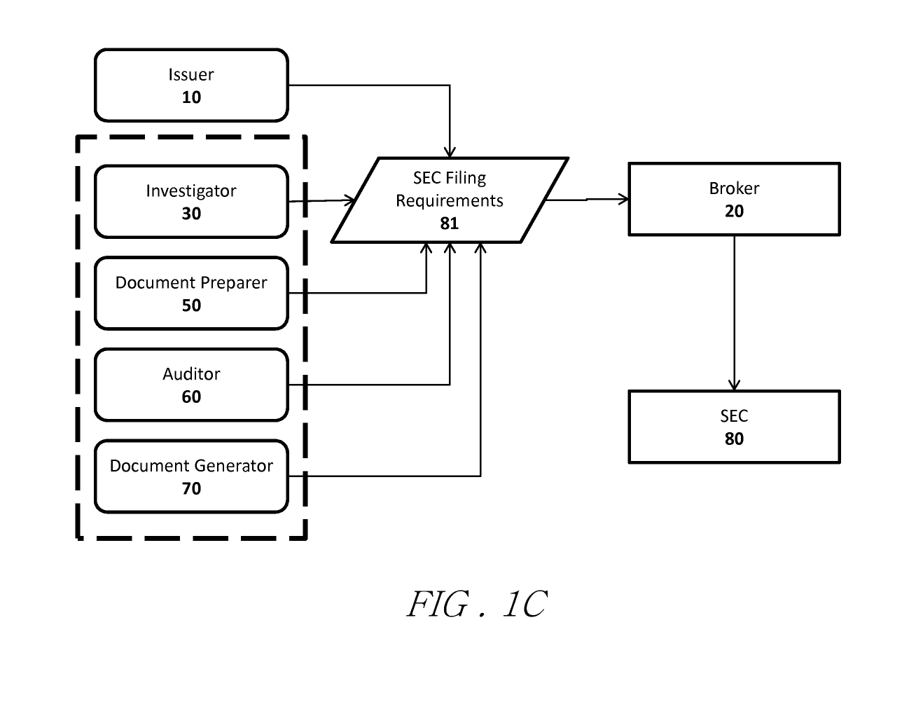

Turning to FIG. 1A, the logic flow chart depicts an intermediary-centric preparation of securities documents 81 for filing at the SEC 80. A broker comprises a register broker individual, a registered broker entity, or a crowdfunding entity. This document preparation procedure initiates the crowdfunding process using a simplified system of a issuer 10, background investigator 30 and auditor 60 providing the required materials. An issuer 10 wishes to obtain so called “crowdsourced” investments from many investors investing small sums of money. An investigator 30 investigates the background of the potential investor, and the officers of the issuer 10. An auditor 60 determines what documents are required under SEC Filing Requirements 81 and also performs some accounting functions. The auditor 60 can be a person, or alternatively can be a computer equipped with knowledge and rules relating to SEC Filing Requirements and accounting practices. Once the SEC filing requirements 81 are met and background and accounting checks out, the requirements and documents are forwarded to a broker 20, which forwards them to the SEC 80.

Turning now to FIG. 1B, a document preparer 50 is added to the process as set forth in FIG. 1A. A document preparer prepares the documents that are required to be filed.

Turning now to FIG. 1C, a document generator is added to the process as set forth in FIG. 1B. A document generator issues the documents for formation, all the issuance documents, and all of the investor documents. All of those documents would be assembled by the document generator, coordinated possibly by the document preparer.

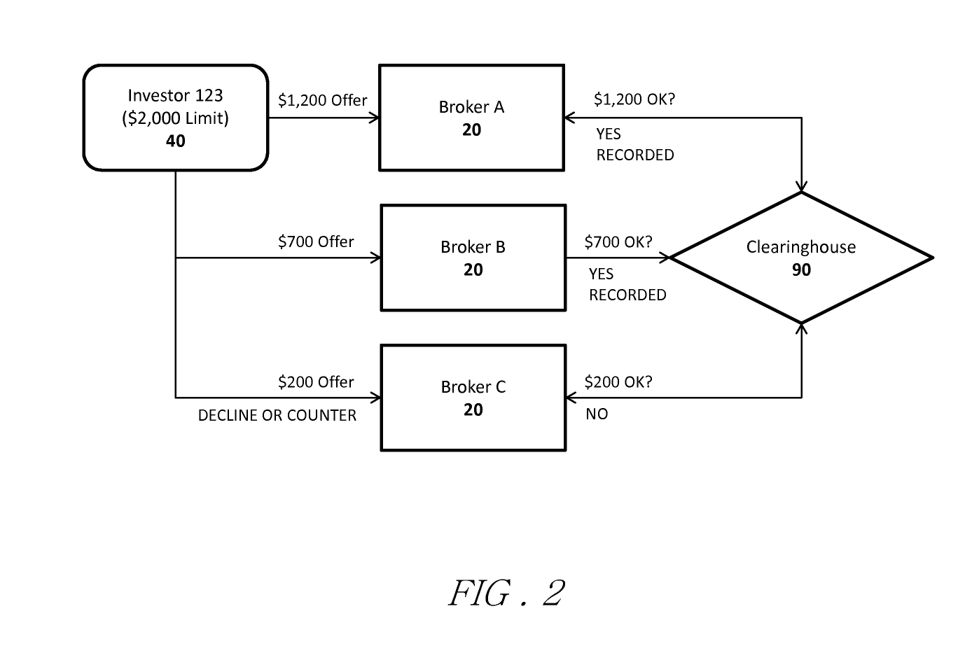

Referring now to FIG. 2, the logic flow chart shows a process, in accordance with an aspect of the present invention, of using a clearinghouse 90 to assure investors 40 do not exceed SEC 80 limits on the investor's 40 total crowdfunding investments. Investor 40 has a statutory crowdfunding investment limit of $2,000 in a calendar year. The investor wishes to offer a $1,200 investment through a first broker 20, labeled Broker A. Preferably before engaging in the expensive process to generate investment documents, as set forth in FIGS. 1A-1C, the Broker sends the investment proposal to clearinghouse 90, along with an identifier for the investor 40 such as a Social Security number. The clearinghouse 90 includes one or more computers acting as servers, and one or more databases containing data relating to crowdfunding investments that have taken place, e.g., during the statutory limitations period which under the JOBS act is currently twelve months. The Clearinghouse 90 also includes machine executable instructions to query the database using the identifier for the investor to determine every investment that has been made by the investor 40 during the statutory period. In this example as set forth in FIG. 2, the Clearinghouse 90 determines that investor 40 has at least $1,200 remaining in his investment quota, and returns a “yes” result to the Broker, which puts in motion the process of FIGS. 1A, 1B and/or 1C. Clearinghouse 90 also records the existence of the $1,200 investment in its database. Clearinghouse 90 may also query a database controlled by the SEC to ensure completeness of its own database and therefore compliance with the statutory maximum. The database at Clearinghouse 90 may also contain information related to issuers. Querying the database at Clearinghouse 90 may include a check to make sure the issuer has not exceeded the maximum investment amount in a predetermined time period, after which crowdfunded investing is no longer permitted under the JOBS Act and/or the regulations.

Later, the investor wishes to make a $700 investment with another Broker 20, referred to as Broker B. Broker B sends a request to the Clearinghouse 90, which shows the prior $1,200 investment but no other investments, and determines that Investor 40 is permitted to invest $700 in the issuer represented by Broker B, and returns a “yes” result. Later, Investor 40 informs Broker C that Investor 40 wishes to invest $200 in an issuer represented by Broker C. Broker C sends the request to the Clearinghouse 90. The Clearinghouse 90 queries the database, and the results show a $1,200 investment and a $700 investment, leaving only $100 to invest, The Clearinghouse 90 returns a “no” result to Broker C, because Investor 40 does not have the right under the statute to invest $200. Alternatively, Clearinghouse 90 could provide further reasons for the “no,” result, such as the existence and/or some information regarding the prior investments. In one aspect of the present invention, an additional request can be sent to the Clearinghouse 90 shortly before closing, to ensure that the Investor 40 has not made any intervening investments (e.g., investments that were not cleared through the Clearinghouse but are shown in an SEC database) that might alter his/her compliance status.

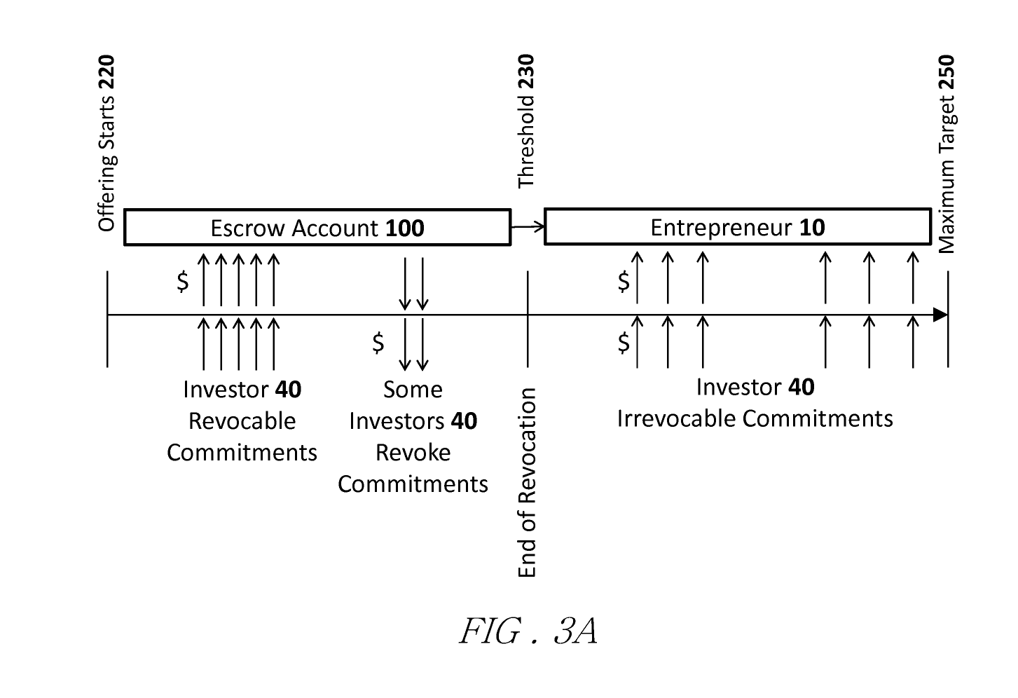

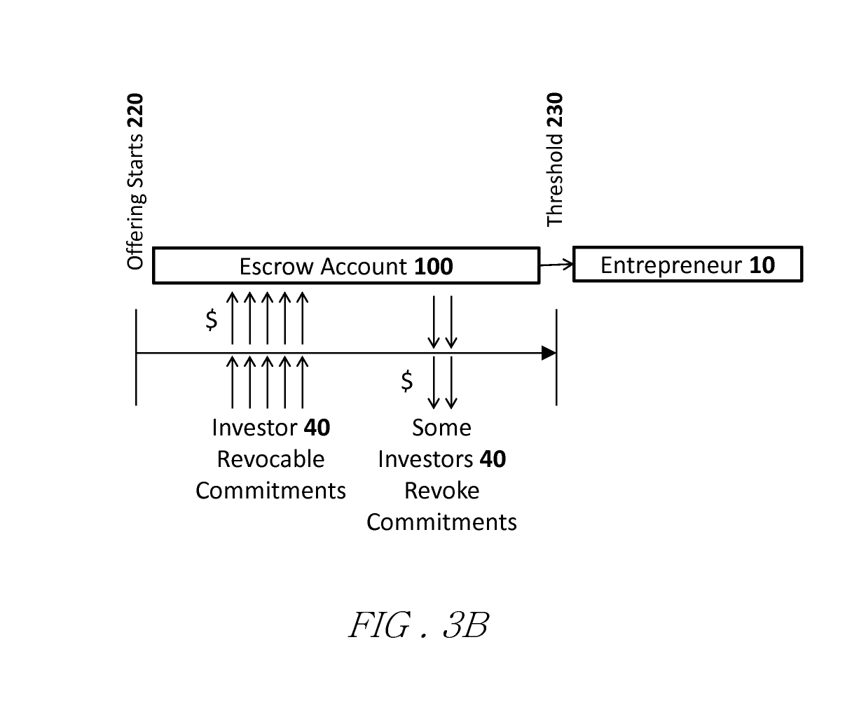

Turning now to FIG. 3A, a timeline depicting the flow of investor's 40 contributions through the escrow account 100 and continuing past the threshold 240 amount to the targeted offering amount 250 or deadline 260 is shown. Investor 40 makes a revocable commitment to invest with entrepreneur 10. The revocable commitment is run through the Clearinghouse 90 as set forth in FIG. 2, and once it passes, the funds are placed in an escrow account 100. Other investors do the same. During a revocation period, some investors revoke their commitments. These revocations are also run through the Clearinghouse 90 and recorded in the database, so that those investors are fee to make future investments without regard to the amount in the revoked commitment. If, at the end of the revocation period, there is a threshold amount 230 in the escrow account 100, the amount in the escrow account 100 is transferred to the entrepreneur 10. Further investors 40 are permitted to make future investments. These investments are run through the Clearinghouse 90 and the commitments are irrevocable and the money forwarded directly to entrepreneur 10 rather than placed in the escrow account 100. When a maximum target 250 is reached, no further investments are accepted.

FIG. 3B is a timeline illustrating the flow of investor's 40 contributions through the escrow account 100 but ending when the threshold 240 amount is achieved. FIG. 3 is a simplified version of FIG. 3A, in an alternate scenario. In the scenario depicted by FIG. 3B, the Threshold 230 is also the maximum target, denoted as 250 in FIG. 3A. When the minimum and maximum are the same, money is held in escrow account 100 until the threshold 230 is met and all of the threshold investments are irrevocable. At that time, the funds in escrow account 100 are transferred to the entrepreneur 10.

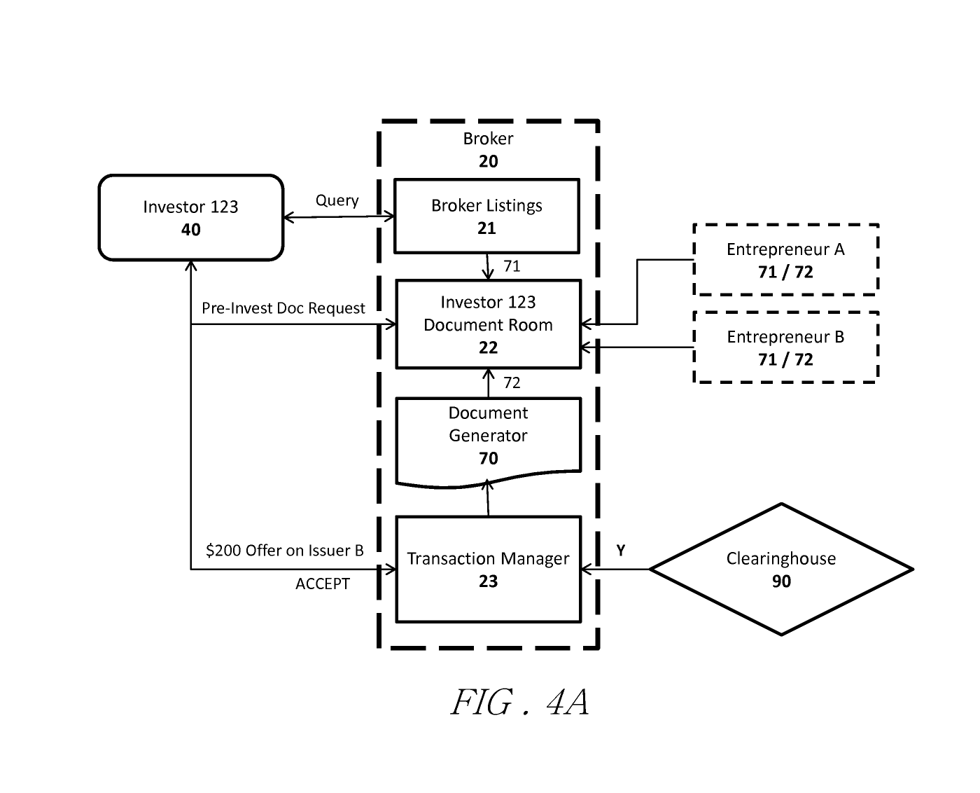

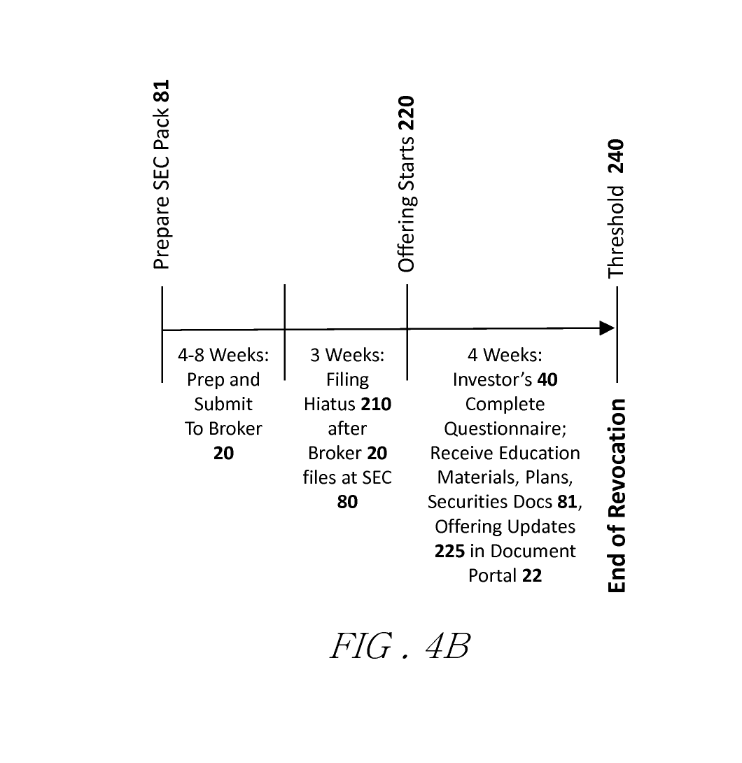

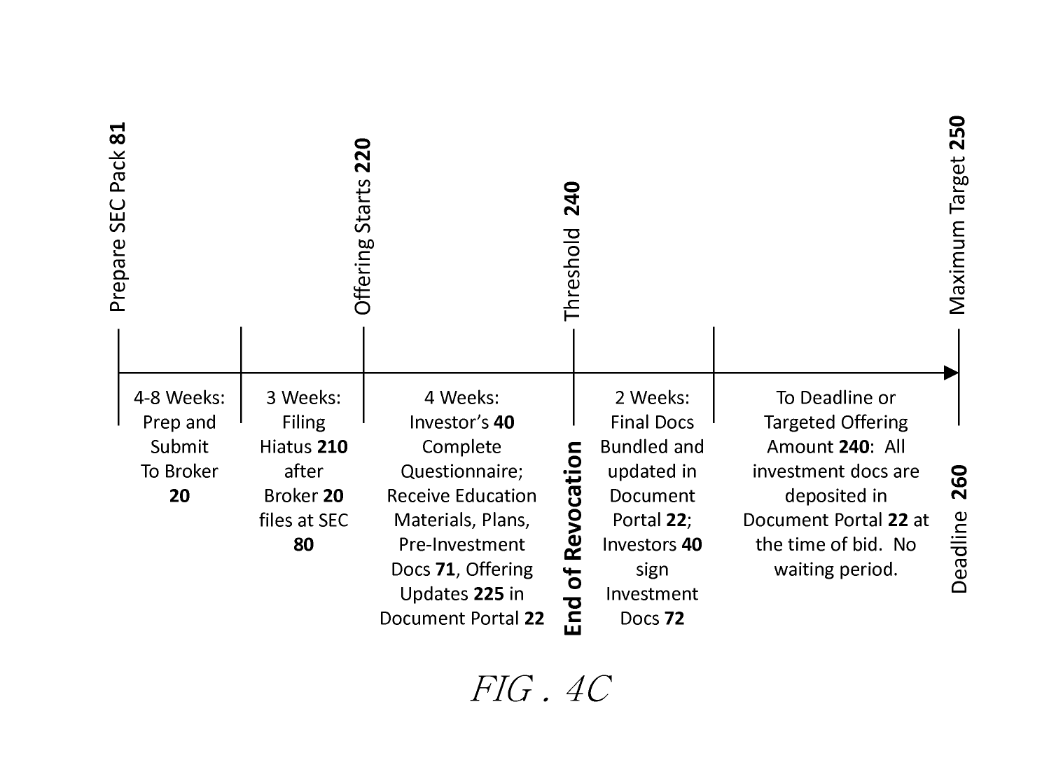

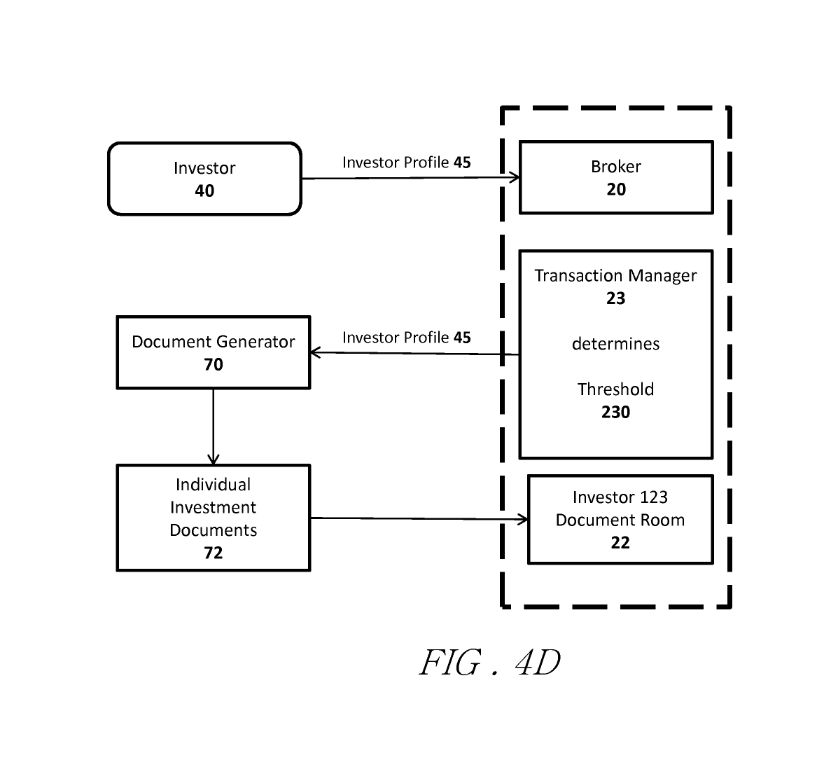

Turning now to FIG. 4A, a flow chart depicting the flow of documents 71, 72 through the crowdfunding process is shown. The process chart begins when the investor 40 queries the broker listings 21 until the document generator 70 issues the final investment documents 71 to the investor document room 22.

Investor 40 sends a query to the broker system asking for information about offering from the broker system, which goes to the broker listing 21. That broker listing could be everything that the broker has, the system can provide a user interface for Investor 40 to query a database to search for an appropriate investment. Investor 40 then informs the broker that he/she is interested in one or more particular issuers. The broker then uses portal software on a general purpose computing device to create a virtual, electronic investment document room for the individual Investor 40, in the system. The document generator then creates the pre-investment documents which include the PPM, the investment documents without the investor's name in it, the audits, the investigative report, and any other documents required under the JOBS Act or SEC Rules to be submitted to the SEC.

That information is sent up to the investor room so the investor can then, as shown in the left-hand side of FIG. 4A, use the pre-investment document request to query the investment document room 21 to be able to look at the documents for that particular issuer. Within the investment document room, there may be several other subfolders for different issuers with whom the investor has either invested or explored investing. IF the investor decides he wishes to invest, he can, as shown in this example, makes a $200 offer on Issuer B. The transaction manager then sends that $200 offer to the Clearinghouse 90 as a revocable commitment. As set forth in FIG. 2, the Clearinghouse matches Investor 40's revocable and irrevocable commitments to ensure compliance with the rules and limits, and then returns that information approval back to the transaction manager, in this example returning a “yes,” result, indicating that Investor 40 can make a $200 offer on Issuer B. The Clearinghouse 90 then records that revocable commitment in the database so that the next time the investor makes an offer, that $200 is counted against his/her annual maximum. When the threshold amount is reached, transaction manager 23 sends that information up to document generator 70. Document generator 70 would then create the investment documents and add them to the pre-investment documents inside of the investor document room 22.

Turning now to FIG. 4B, a timeline illustrating the flow of documents 71, 72 from the preparation of the SEC package (81) and ending when the threshold (240) amount is completed, is shown. Beginning on the left-hand side, the document generator prepares the documents, the background checks and audits are completed, the PPM is prepared and the documents 81 are and submitted to the broker 20 electronically. The broker 20 then submits the documents 81 to the SEC 80. A filing hiatus 210, estimated to be 3 weeks, follows and, under the Act, the offering starts immediately after that, we see at 220. During a second period of time, estimated to be 4 weeks though it could differ longer or shorter, the investor completes the questionnaires, receives education material, plans, security documents, and any updates to the offerings itself 225, are all placed an investment document room of the portal 22. And we stay that way until we get to the end of the revocation period and the threshold 240.

FIG. 4C is a timeline illustrating the flow of documents starting from the preparation of the SEC package (81) and ending when the maximum target (250), or deadline (260), is achieved. The document generator and the document preparer prepare the SEC documents 81, which includes the background checks on all the executives, the audits of the previous years, preparing the PPM, updating the business resume, doing the pro forma, the business plan and updating the pro forma, etc. It is estimated to take 4 to 8 weeks to get that package ready to submit to the broker. The broker then reviews the SEC package 81 and sends it over to the SEC. After it is sent to the SEC, there is a regulatory period, currently exactly 3 weeks of filing hiatus after the broker files at the SEC and then the offering period begins. After that the investors receive the completed questionnaire, receive education materials, plans, pre-investment documents, offering updates and all documents go into an investor document room 22 of the portal. The investor then has approximately two weeks, the documents are gathered and, sent to the investor, and the investor has approximately 2 weeks to make a decision where revocable commitments become irrevocable commitments 240 and at the end of the 2 weeks all of the commitments become irrevocable. In this example, the end of the threshold period is the minimum amount that can be raised and there is a larger, maximum target or deadline to the raise. The final section of the timeline, to the right, all investment documents are deposited into the document portal, at the time of the threshhold, and there is no waiting period and the investor has irrevocable commitments at that time.

Turning now to FIG. 4D, a flow chart depicting the flow of investment documents 72 and data to trigger the document generation is shown. The investor 40 prepares an investor profile which would be information that would be used in the investment documents, such as name and address, income, those kinds of things. That information in the profile is stored in the portal and will be transmitted to the broker and stored in the broker system. The transaction manager receives the investor profile for the information and determines the threshold (a minimum amount of money invested in the venture before investments are sent to the issuer) has been met so it sends the investor profile over to document generator. The initial pre-investment documents, such as a commitment form, do not have investor specific information in it. That information is then updated in the investment, added to the forms and then put into the document generator to create the investment documents. Some of the information in the investment documents needs to be determined at the end of the threshold period. So the individual investment documents are placed inside the investor document room 22 and that is the end of it, So this whole chart is really focused on how the transaction manager triggers the investment documents instead of the pre-investment documents.

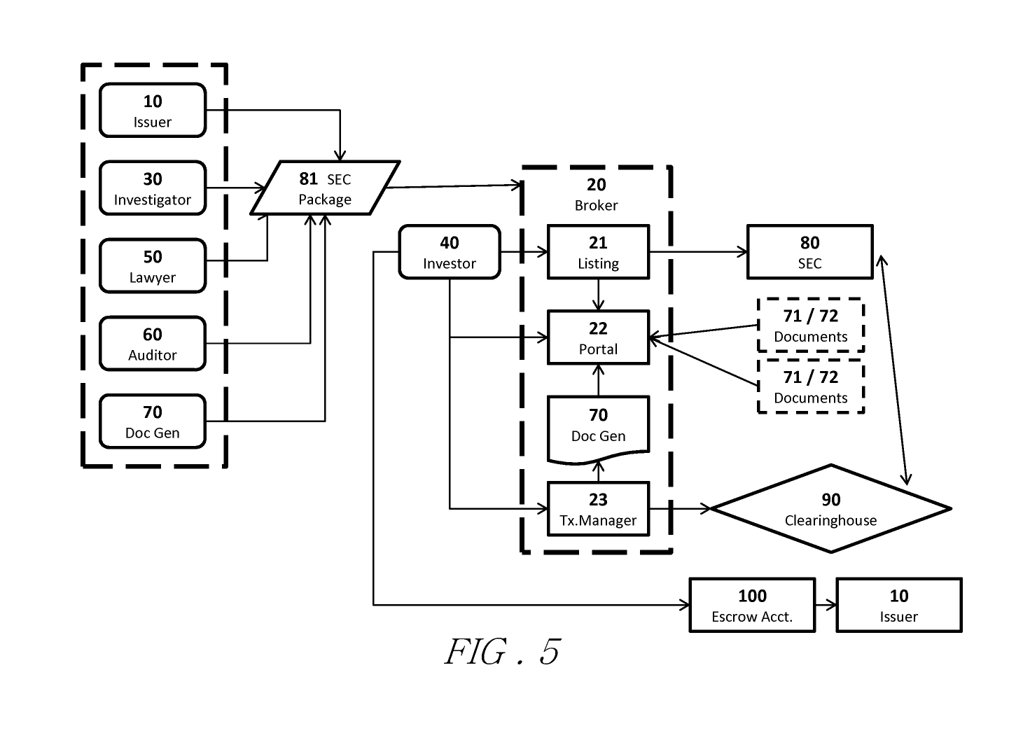

Turning now to FIG. 5 demonstrating the invention through the entire crowdfunding process beginning at the preparation of the securities documents 81 to the depositing of the investment dollars in the issuer's 10 account. The issuer 10 is the company in which the investor 40 would be investing. Background investigator 30 investigates the background of the principal officers of the company. Background investigator 30 may be an automated system which retrieves public data and assembles the data in a useful, standardized format for quick review by the broker 20 and government agencies 80. Standard information for the investigator 30 system may comprise credit reports; tax information; associated government filings such as through SEC and state business records; and property reports. Document preparer 50 prepares the initial package of documents. The document preparer maybe an automated processor-based system which collects and suspends information from various issuers 10, investigators 30, lawyers 50, auditors 60, and other professional systems until the filing requirements have been met. Once those are met, the SEC package 81 is unsuspended and forwarded to the broker 20. The prepared documents comprise the SEC filing package 81, the preinvestment documents 71 and the investment documents 72. The SEC filing package comprises requirements under the Jobs Act and SEC rules such as the business plan, pro forma reports, officer backgrounds, subscription agreements, licensing agreements, partnership agreements, audits of previous financials, employment agreements, investment agreements, and formation documents. Auditor 60 reviews financial statements. In the preferred embodiment the auditor is an automated system which matches pre-determines milestone, scorecard, industry standards and accounting standards to produce a standardized report for the broker and government agencies.

Document generator 70 is a software module running on a general purpose computer with a processor. Document generator 70 automatically generates the pre-closing investment documents, which include the terms and conditions of the investment and identify the issuer, but do not identify the investor. The JOBS Act requires the documents to be created early in the process. The issuer 10, background investigator 30, document preparer 50, and document generator 70 are involved in preparing the offering package 81, for eventual submission to the SEC. The offering package 81 are sent to the broker or crowdfunding portal 20. The broker portal 20 submits the documents to the SEC 80. Once the investment is approved, and any required waiting periods are met, the offer is listed in the portal for investor 40. Using a user interface such located on the World Wide Web, the investor 40 makes a general inquiry of the broker 20 listings 21. If the investor 40 expresses interest in a particular issuer 10, the broker system, generates a document portal 22, or document room 22, and deposits the preinvestment documents 71 for private access to the investor 40. If an investor 40 chooses to subscribe to the investment, the investor 40 does so through the transaction manager 23, located on the broker system 20, which sends the information about the investor 40 and the amount to be invested, to the Clearinghouse 90 pursuant to the process set forth in FIG. 2. Once the Clearinghouse 90 clears the investment, the document generator 70 completes the closing investment documents. Closing investment documents 72 are the same as pre-investment documents 72, with the addition of investor identifying information. In another embodiment, the investment documents 72 are generated after the clearinghouse has signaled the broker the threshold period has been reached. At that time the document generator 70 loads the investment documents, populated with the investor's 40 data into each investor's 40 document portal directly or through the broker system. 20. Once this is completed, and any required waiting periods are met, the investor 40 will send funds to an escrow agent, which will forward them to the issuer once investment thresholds are met.

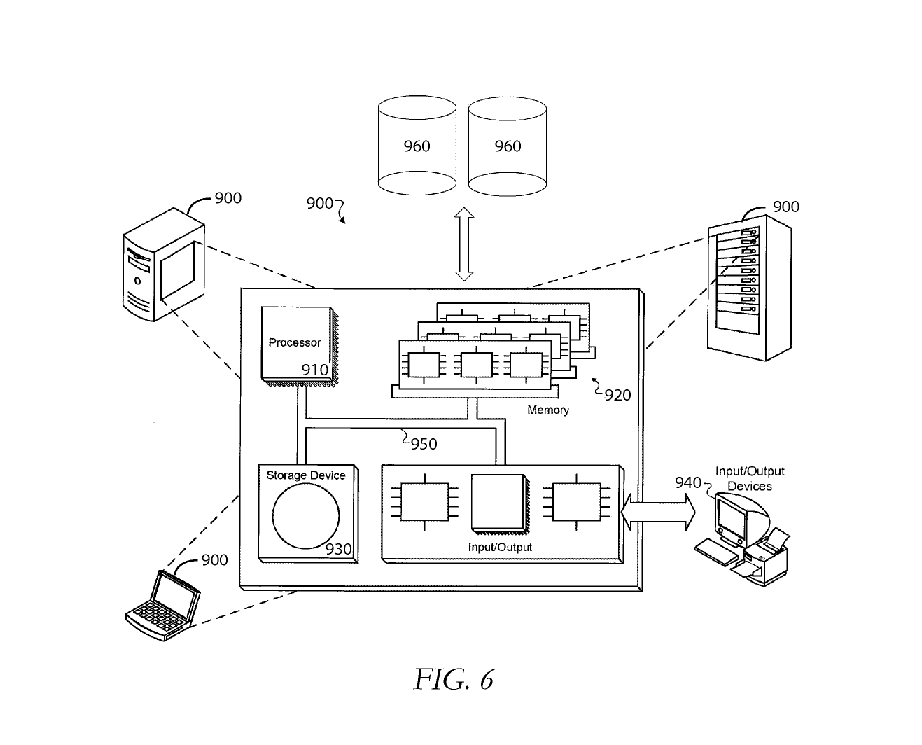

FIG. 6 is a diagram displaying a general purpose computer on which the system and method of the present disclosure may be implemented according to an aspect of present disclosure. The computer system 900 may execute at least some of the operations described above. Computer system 900 may include processor 910, memory 920, storage device 930, and input/ output devices 940. Some or all of the components 910, 920, 930, and 940 may be interconnected via system bus 950. Processor 910 may be single or multi-threaded and may have one or more cores. Processor 910 may execute instructions, such as those stored in memory 920 or in storage device 930. Information may be received and output using one or more input/output devices 940.

Memory 920 may store information and may be a computer-readable medium, such as volatile or non-volatile memory. Storage device 930 may provide storage for system 900 and may be a computer-readable medium. In various aspects, storage device 930 may be a flash memory device, a floppy disk device, a hard disk device, an optical disk device, or a tape device.

Input/output devices 940 may provide input/output operations for system 900. Input/output devices 940 may include a keyboard, pointing device, and microphone. Input/output devices 940 may further include a display unit for displaying graphical user interfaces, speaker, and printer. External data, such as financial data, may be stored in accessible external databases 960.

The features described may be implemented in digital electronic circuitry, or in computer hardware, firmware, software, or in combinations thereof. The apparatus may be implemented in a computer program product tangibly embodied in an information carrier, e.g., in a machine-readable storage device or in a propagated signal, for execution by a programmable processor; and method steps may be performed by a programmable processor executing a program of instructions to perform functions of the described implementations by operating on input data and generating output.

The described features may be implemented in one or more computer programs that are executable on a programmable system including at least one programmable processor coupled to receive data and instructions from, and to transmit data and instructions to, a data storage system, at least one input device, and at least one output device. A computer program may include set of instructions that may be used, directly or indirectly, in a computer to perform a certain activity or bring about a certain result. A computer program may be written in any form of programming language, including compiled or interpreted languages, and it may be deployed in any form, including as a stand-alone program or as a module, component, subroutine, or other unit suitable for use in a computing environment.

Suitable processors for the execution of a program of instructions may include, by way of example, both general and special purpose microprocessors, and the sole processor or one of multiple processors of any kind of computer. Generally, a processor may receive instructions and data from a read only memory or a random access memory or both. Such a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable, disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as a CRT (cathode ray tube) or LCD (liquid crystal display) monitor for displaying information to the user and a keyboard and a pointing device such as a mouse or a trackball by which the user may provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system may be connected by any form or medium of digital data communication such as a communication network. Examples of communication networks may include, e.g., a LAN, a WAN, and the computers and networks forming the Internet.

The computer system may include clients and servers. A client and server may be remote from each other and interact through a network, such as the described one. The relationship of client and server may arise by virtue of computer programs running on the respective computers and having a client-server relationship to each other.

Benefits, other advantages, and solutions to problems have been described herein with regard to specific embodiments. However, the advantages, associated benefits, specific solutions to problems, and any element(s) that may cause any benefit, advantage, or solution to occur or become more pronounced are not to be construed as critical, required, or essential features or elements of any or all the claims or the invention. As used herein, the terms “comprises”, “comprising”, or any other variation thereof, are intended to cover a non-exclusive inclusion, such that a process, method, article, or apparatus composed of a list of elements, that may include other elements not expressly listed or inherent to such process, method, article, or apparatus.

Numerous additional modifications and variations of the present disclosure are possible in view of the above teachings. It is therefore to be understood that within the scope of the appended claims, the present disclosure may be practiced other than as specifically described herein.

What is claimed is:

1. A method for crowdfunding, the method comprising:
a) Transmitting, from a requesting terminal to a Clearinghouse, offer data representing an offer to contribute capital to an entrepreneur, said offer data comprising current amount data representing an amount of capital being offered for investment, and current investor identification data, the Clearinghouse comprising a processor and a storage medium comprising a database;
b) Querying the database for investor historical records relating to prior investments and pending offers containing prior investor identification data matching the current investor identification data, during a specified period of time, the historical records comprising historical amount data;
c) Using the processor to calculate the sum of all historical amount data and the current amount data, and arithmetically comparing the result to a maximum investment amount;
d) Returning a positive result if the sum does not exceed the maximum investment amount, and returning a negative result if the sum exceeds the maximum investment amount; and
e) Transmitting result data comprising the positive result or the negative result to the requesting terminal.

2. The method of claim 1, wherein the historical amount data comprises an amount of capital invested or offered.

3. The method of claim 1, wherein the pending offers are revocable commitments.

4. The method of claim 1, further comprising the step of the Clearinghouse querying a third party database for further historical records, to ensure completeness of the database at the Clearinghouse.

5. The method of claim 4 wherein said third party database is managed by the government.

6. The method of claim 1, wherein the offer data further comprises issuer identification data, further comprising the steps of querying the database for issuer historical records relating to prior investments in the issuer during an issuer limitations period, said issuer historical records comprising issuer investment amounts, and using the processor to calculate the sum of all issuer investment amounts and the current amount data to determine if the issuer is permitted to accept crowdfunded investments.

7. The method of claim 1, further comprising the steps of
f) generating required documents;
g) storing investment documents in a virtual investment document room; and
h) transferring invested funds.

8. A portal for managing a crowdfunded investment, comprising a general purpose computer comprising a processor, a storage medium, a connection to a computer network, and software modules for
a) An investment browser interface to facilitate the selection of an investment in a company by an investor of a specified amount of capital;
b) A document generator for preparing required documents;
c) A virtual investment document room comprising stored investment documents and an investment document browsing interface;
d) An interface for interacting with a Clearinghouse to determine whether the investor is permitted to invest based on the investor's prior investments, and to determine whether a threshold investment amount has been reached to enable invested funds to be transferred to the company;
e) An interface for transmitting the investment document filings to the Securities and Exchange Commission, and
f) A funds transfer module to transfer the invested funds to the company or to an escrow agent, in accordance with the results from the Clearinghouse.

9. The portal of claim 8 wherein said required documents comprise pre-investment documents.

10. The portal of claim 8 wherein said required documents comprise investment documents.

11. The portal of claim 8 wherein said document filings comprise disclosures and investment documentation.

12. The portal of claim 8, further comprising an interface for interacting with an SEC database to determine whether the investor is permitted to invest based on the investor's prior investments.

13. The portal of claim 12, further comprising an interface for interacting with the Clearinghouse to determine whether the company is eligible to accept crowdfunded investments

14. The portal of claim 13, further comprising an interface for interacting with the SEC database to determine whether the company is eligible to accept crowdfunded investments.
